(19) United States
(12) Patent Application Publication
(10) Pub. No.: US 2005/0200195 A1
(43) Pub. Date: Sep. 15, 2005

(54) Hydraulic device

(76) Inventor: Teruaki Yogo, Aichi-Ken (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/520,890

(22) PCT Filed: Mar. 3, 2004
(86) PCT No.: PCT/JP04/02657

§ 371 Date: Jan. 11, 2005

(30) Foreign Application Priority Data
Mar. 3, 2003 (JP) 2003056259

(51) Int. Cl. B60T 8/34

(52) U.S. Cl. 303/113.1

(57) ABSTRACT

A fluid pressure apparatus capable of achieving stable pressing is obtained. The fluid pressure apparatus comprises a fluid pressure pump (1) driven by an electric motor (6) and rotatable in both directions. Both ports (14, 16) of a fluid pressure cylinder (12) are respectively connected to both ports (2, 4) of the fluid pressure pump (1) via a pair of flow paths (8, 10). A throttle (32) is disposed on a leak flow path (30) which communicates a high pressure side with a low pressure side of the pair of flow paths (8, 10), while the pressing operation is performed by a fluid pressure cylinder (12). Furthermore, the fluid pressure apparatus comprises a position control circuit (38) for controlling the electric motor (6) based on a position detected by a movement detection sensor (34) for detecting movement by the fluid pressure cylinder (12), a pressure control circuit (40) for controlling the electric motor (6) based on pressure in the flow path (10) on the high pressure side detected by the pressure sensor (36), and a switch circuit (42) for switching control by the poison control circuit (38) to control by the pressure control circuit (40).

### TECHNICAL FIELD

The present invention relates to a fluid pressure apparatus in which both ports of a fluid pressure pump, driven by an electric motor and rotatable in both directions, are respectively connected to both ports of a fluid pressure actuator via a pair of flow paths.

### BACKGROUND ART

As disclosed in Publication of Unexamined Japanese Patent Application No. 10-26101 (pages 2 and 3, FIG. 1), there is conventionally known a fluid pressure apparatus in which both ports of a fluid pressure pump, driven by an electric motor and rotatable in both directions, are respectively connected to both ports of a fluid pressure actuator via a pair of flow paths. In this fluid pressure apparatus, the operational direction of the fluid pressure actuator is changed by changing the rotational direction of the electric motor. The movement by the fluid pressure actuator is detected by a sensor. And the drive speed and the stop position of the fluid pressure actuator as well as the rotational speed of the electric motor are controlled.

However, in the conventional fluid pressure apparatus, when the fluid pressure actuator is driven to move an object to be transferred and a state, in which the pressing force applied by the fluid pressure actuator is retained, is maintained by pressing against a stationary object such as a wall or a stopper, if the pressure of pressure liquid supplied to the fluid pressure actuator is over a predetermined level, the drive of the electric motor is stopped. When the pressure of pressure liquid is lowered due to a leak from the fluid pressure pump, the electric motor is driven again so that the pressure of pressure liquid is at a predetermined level. However, there occurs a problem that controllability deteriorates, because the pressing force of the fluid pressure actuator is fluctuating, and operation and stopping of the electric motor are frequently repeated.

An object of the present invention is to provide a fluid pressure apparatus capable of achieving stable pressing.

### DISCLOSURE OF INVENTION

To attain the aforementioned object, the present invention has taken the following measures: There is provided a fluid pressure apparatus included with a fluid pressure pump driven by an electric motor and rotatable in both directions. Both ports of a fluid pressure actuator are respectively connected to both ports of the fluid pressure pump via a pair of flow paths. Pressing against a stationary object is performed by operation of the fluid pressure actuator. And a throttle is disposed on a leak flow path that communicates a high pressure side with a low pressure side of the pair of flow paths, while the pressing operation is performed by the fluid pressure actuator.

The fluid pressure apparatus comprises a position control device for controlling the electric motor based on a position detected by a movement detection sensor for detecting movement by the fluid pressure actuator, and a pressure control device for controlling the electric motor based on pressure detected by a pressure sensor for detecting pressure in the flow path on the high pressure side. Furthermore, a switch device may be provided for switching from control of the electric motor by the position control device to control by the pressure control device.

The switch device may switch from control of the electric motor by the position control device to control by the pressure control device based on detection by the movement detection sensor.

The fluid pressure actuator may be any one of a single-rod type fluid pressure cylinder, a double-rod type fluid pressure cylinder, and a fluid pressure motor.

The fluid pressure pump may be a piston pump.

Furthermore, an electromagnetic valve may be disposed on the leak flow path.

### BRIEF DESCRIPTION OF THE DRAWINGS

FIG. 1 is a circuit diagram of a fluid pressure apparatus according to a first embodiment of the present invention.

FIG. 2 is a graph showing variance in pressure under control of repeating operation and stopping of a conventional electric motor.

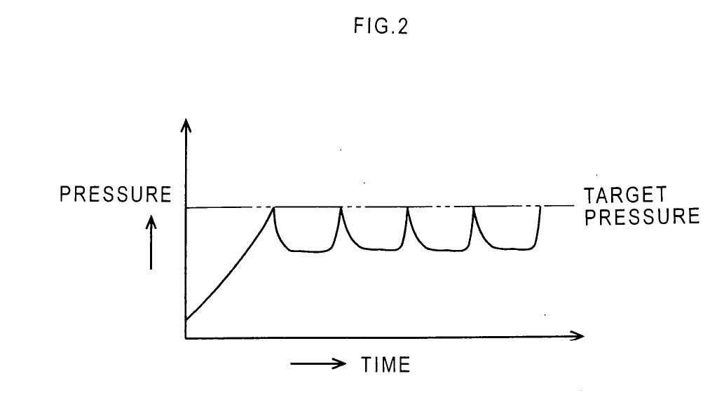

### BEST MODE FOR CARRYING OUT THE INVENTION

An embodiment of the present invention will be described hereinafter in detail with reference to the drawings.

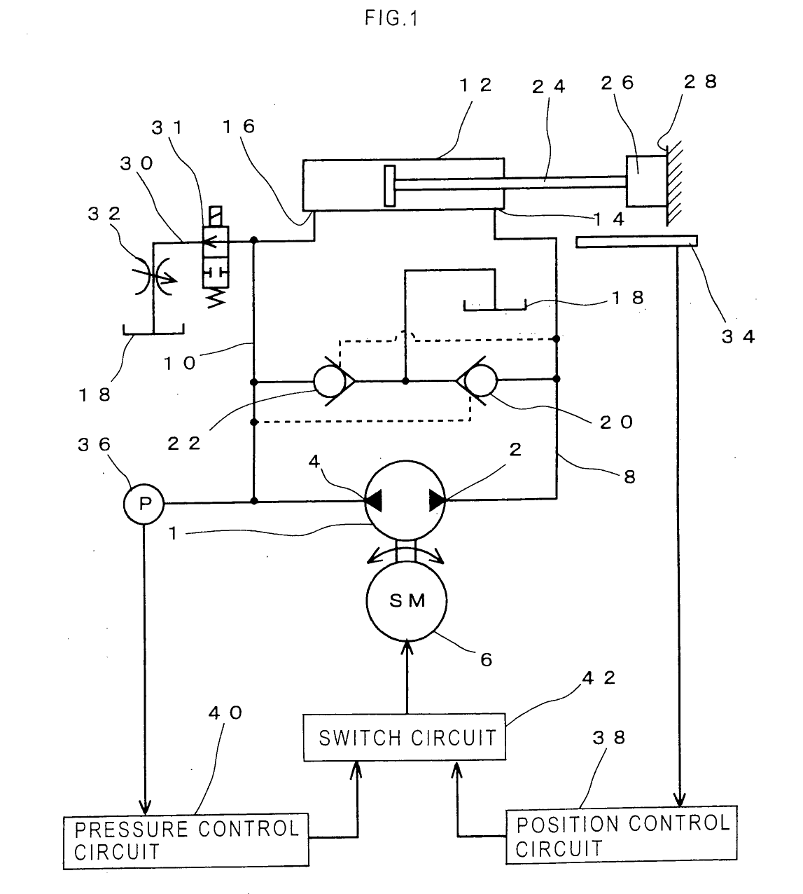

As shown in FIG. 1, a fluid pressure pump 1 is a swash plate piston pump rotatable in both directions. The fluid pressure pump 1 takes in operation liquid from a first port 2 and discharges it to a second port 4 when rotating in a forward direction, and takes in operation liquid from the second port 4 and discharges it to the first port 2 when rotating in a reverse direction. The fluid pressure pump 1 is connected so as to be rotated and driven by an electric motor 6, such as servo motor.

The first port 2 and the second port 4 are respectively connected to a rod side flow path 8 and a head side flow path 10. The rod side flow path 8 is connected to a rod side port 14 of a single-rod type fluid pressure cylinder 12. The head side flow path 10 is connected to a head side port 16 of the fluid pressure cylinder 12. The fluid pressure actuator is not restricted to a single-rod type fluid pressure cylinder 12. The fluid pressure actuator may be a double-rod type fluid pressure cylinder and a fluid pressure motor. As long as it is a fluid pressure actuator, it is practicable.

The rod side flow path 8 is connected to a tank 18 as a low-pressure side via a pilot check valve 20. The pilot check valve 20 is provided in a direction to allow flow from the tank 18 to the rod side flow path 8. The pilot check valve 20 introduces the liquid pressure of the head side flow path 10 as a pilot pressure. The pilot check valve 22 is connected in such a manner that when the liquid pressure of the head side flow path 10 increases, the pilot check valve 20 is opened to communicate between the rod side flow path 8 and the tank 18.

Furthermore, the head side flow path 10 is connected to the tank 18 via the pilot check valve 22. The pilot check valve 22 is provided in a direction to allow flow from the tank 18 to the head side flow path 10. The pilot check valve 22 introduces the liquid pressure of the rod side flow path 8 as a pilot pressure. The pilot check valve 22 is connected in such a manner that when the liquid pressure of the rod side flow path 8 increases, the pilot check valve 22 is opened to communicate between the head side flow path 10 and the tank 18.

In the present embodiment, the fluid pressure cylinder 12 is configured to move an object to be transferred 26 via a rod 24 and to press the moved object to be transferred 26 against a stationary object such as a wall 28. The stationary object is not restricted to a wall. The rod 24 may be pressed against a not-shown stopper as a stationary object.

In a pressed state, high pressure operation oil is supplied from the head side port 16 to the fluid pressure cylinder 12 through the head side flow path 10. This head side flow path 10 is connected to a leak flow path 30 which links with the tank 18. The leak flow path 30 is provided with an electromagnetic valve 31 and a variable throttle 32.

In the present embodiment, the rod 24 is protruded to press against the stationary object. However, when the rod 24 is moved in a retracting direction to press the object to be transferred 26 against the stationary object, the leak flow path 30, the electromagnetic valve 31, and the variable throttle may be provided on the rod side flow path 8.

On the other hand, a movement detection sensor 34 is provided for detecting movement of the object to be transferred 26 by the fluid pressure cylinder 12. The movement detection sensor 34 outputs a moving position signal in accordance with the movement of the object to be transferred 26. A pressure sensor 36 is disposed on the head side flow path 10. The pressure sensor 36 detects the pressure of pressure liquid of the head side flow path 10 and outputs a pressure signal.

The movement detection sensor 34 and the pressure sensor 36 are respectively connected to a position control circuit 38 and a pressure control circuit 40. The position control circuit 38 and the pressure control circuit 40 are connected to the electronic motor 6 via a switch circuit 42. These circuits may be configured either by hardware or by software. The position control circuit 38 controls the electronic motor 6 based on a moving position signal transmitted from the movement detection sensor 34 so that the object to be transferred 26 is moved to a predetermined moving position.

The pressure control circuit 40 is configured to control the electric motor 6 so that the pressure of pressure liquid of the head side flow path 10 detected by the pressure sensor 36 is at a predetermined level. Specifically, the electric motor 6 is rotated in a forward direction to discharge pressure liquid from the fluid pressure pump 1 to the head side flow path 10, and controlled so that the pressure of pressure liquid of the head side flow path 10 is at a predetermined level.

The switch circuit 42 is configured to switch between control of the electric motor 6 by the signal transmitted from the position control circuit 38 and control of the electric motor 6 by the signal transmitted from the pressure control circuit 40. For example, when the movement detection sensor 34 detects that the object to be transferred 26 is pressed against the wall 28, switching is performed from control by the position control circuit 38 to control by the pressure control circuit 40.

Operation of the fluid pressure apparatus in the present embodiment will be described hereinafter.

First, when the electric motor 6 is rotated in a forward direction, the operation liquid is taken in from the first port 2, and the pressure liquid is discharged from the second port 4. Thus, the operation liquid is taken in from the rod side port 14 of the fluid pressure cylinder 12 to the first port 2 of the fluid pressure pump 1 via the rod side flow path 8. And, the pressure liquid is supplied from the second port 4 to the fluid pressure cylinder 12 via the head side flow path 10 and the head side port 16. Consequently, the rod 24 is driven in a pulling direction.

In this case, there occurs a difference between the amount of the operation liquid discharged from the rod side port 14 and the amount of the pressure liquid taken in from the head side port 16. The difference therebetween is the same as the volume of the rod 24. Since the pressure in the rod side flow path 8 is lowered, the pilot check valve 20 is opened. The shortage of the operation oil is supplied from the tank 18 to the rod side flow path 8 via the pilot check valve 20.

When the electric motor 6 is rotated in a reverse direction, the operation liquid is taken in from the second port 4 of the fluid pressure pump 1 via the head side port 16 of the fluid pressure cylinder 12 and the head side flow path 10. The pressure liquid is supplied to the fluid pressure cylinder 12 via the first port 2, the rod side flow path 8, and the rod side port 14. Thus, the rod 24 is driven in a pulling direction.

In this case, as in described above, there occurs a difference between the amount of the operation liquid discharged from the head side port 16 and the amount of the pressure liquid taken in from the rod side port 14. The difference therebetween is the same as the volume of the rod 24. The pilot check valve 22 is opened by the operation of pilot pressure from the rod side flow path 8. The excess of operation liquid is discharged from the head side flow path 10 to the tank 18. In case that the fluid pressure cylinder 12 is a double-rod type, it is not necessary to provide the pilot check valves 20 and 22.

When the electric motor 6 is connected to the position control circuit 38 by the switch circuit 42, the moving position of the object to be transferred 26 is detected by the movement detection sensor 34 so that the object to be transferred 26 is moved to a predetermined position. The rotational speed of the electric motor 6 is controlled so that the moving speed of the object to be transferred 26 is at a predetermined speed.

As shown in FIG. 1, when the object to be transferred 26 is moved by the fluid pressure cylinder 12 to be retained in a pressed state against the wall 28 as a stationary object, switching is performed so as to connect between the pressure control circuit 40 and the electric motor 6 by the switch circuit 42. The switch for connection by the switch circuit 42 may be performed based on the moving position of the object to be transferred 26 detected by the movement detection sensor 34. Alternatively, it may be performed when the pressure detected by the pressure sensor 36 is over a predetermined level.

The pressure control circuit 40 controls the electric motor 6 based on the pressure of pressure liquid of the head side flow path 10 detected by the pressure sensor 36. First, an actuating signal is transmitted to the electromagnetic valve 31, and the electromagnetic valve 31 is opened. Consequently, in the head side flow path 10, the pressure liquid is returned to the tank 18 through the electromagnetic valve 31 and the variable throttle 32.

The pressure control circuit 40 controls rotation of the electric motor 6 so that the pressure detected by the pressure sensor 36 is at a predetermined level. If the amount of pressure liquid discharged from the fluid pressure pump 1 is more than the amount of pressure liquid caused by an internal leak in the fluid pressure pump 1 or the amount of pressure liquid returned from the leak flow path 30 to the tank 18, the pressure in the head side flow path 10 increases. On the contrary, if the discharged amount is less, the pressure in the head side flow path 10 decreases. Therefore, even if the pressure liquid is returned from the leak flow path 30 to the tank 18, the pressure in the head side flow path 10 can be controlled.

To drive the fluid pressure pump 1, a torque more than the total of reverse-rotation torque from pressure in the head side flow path 10 and friction torque at the time of driving the fluid pressure pump 1 is minimally required. The electric motor 6 is driven by a slightly larger torque than this torque, and then the pressure liquid is discharged from the fluid pressure pump 1. By adjusting the opening degree of the variable throttle 32, returning the excess of the pressure liquid to the tank 18, and continuously rotating the electric motor 6 at a low speed, the pressure within the head side flow path 10 is controlled at a predetermined level. Also, since the electric motor 6 is continuously rotated, control of repeating rotation and stopping of the electric motor 6 is not performed.

The opening degree of the variable throttle 32 may be set by experiment or the like. In case that the opening degree is preliminarily determined, a fixed throttle may be used. Also, the electromagnetic valve 31 may be provided according to necessity. It may be configured such that the electromagnetic valve 31 is not provided and that the pressure liquid continuously leaks from the leak flow path 31 to the tank 18, regardless of the switching of the switch circuit 42.

The invention is not restricted to the embodiment as described above, and may be practiced or embodied in still other ways without departing from the subject matter thereof.

As described above, in the fluid pressure apparatus of the present invention, since the pressure liquid of the high pressure side flow path is returned from the leak flow path to the low pressure side via the throttle with the fluid pressure actuator pressed, control of repeating operation and stopping of the electric motor is not performed. Consequently, such an effect is obtained that stable pressing is achieved.

### INDUSTRIAL APPLICABILITY

According to the present invention, a fluid pressure apparatus capable of achieving a stable pressing can be provided.

1-6. (canceled)

7. A fluid pressure apparatus provided with a fluid pressure pump driven by an electric motor and rotatable in two directions, in which both ports of a fluid pressure actuator are respectively connected to both ports of the fluid pressure pump via a pair of flow paths and pressing against a stationary object is performed by operation of the fluid pressure actuator;
wherein a throttle is disposed on a leak flow path that communicates with a high pressure side and a low pressure side of the pair of flow paths, while a pressurizing operation is performed by the fluid pressure actuator.

8. The fluid pressure apparatus according to claim 7, further comprising a position control device for controlling the electric motor based on a position detected by a movement detection sensor for detecting movement by the fluid pressure actuator, a pressure control device for controlling the electric motor based on a pressure detected by a pressure sensor for detecting the pressure in the high pressure flow path, and a switch device for switching from control of the electric motor by the position control device to control by the pressure control device.

9. The fluid pressure apparatus according to claim 8, wherein the switch device switches from control of the electric motor by the position control device to control by the pressure control device based on detection by the movement detection sensor.

10. The fluid pressure apparatus according to claim 7, wherein the fluid pressure actuator is one of a single-rod type fluid pressure cylinder, a double-rod type fluid pressure cylinder, and a fluid pressure motor.

11. The fluid pressure apparatus according to claim 7, wherein the fluid pressure pump is a piston pump.

12. The fluid pressure pump according to claim 7, wherein an electromagnetic valve is disposed along the leak flow path.
